(19) United States
(12) Patent Application Publication
(10) Pub. No.: US 2009/0176457 A1
(43) Pub. Date: Jul. 9, 2009

(54) Apparatus and method for communicating with moving receivers

(76) Inventors: James J. Christensen, Knoxville, TN (US); Don W. Bible, Clinton, TN (US)

Correspondence Address: ROBERT J. LAUF, 998 W. OUTER DRIVE, OAK RIDGE, TN, 37830, US

(21) Appl. No.: 12/006,609

(22) Filed: Jan. 4, 2008

(51) Int. Cl. H04B 1/00; H04B 7/00

(52) U.S. Cl. 455/69

(57) ABSTRACT

An apparatus for communicating with mobile receivers for emergency notification and other purposes comprises a localized (low power) transmitter capable of transmitting short bursts of compressed audio or video messages over a selected spatial range. The apparatus further contains a means of measuring the relative speed of the transmitter and receiver(s) and adjusting the transmission accordingly (for example by increasing the output power, shortening the burst length, or increasing the burst repetition rate). In this way, the effective “footprint” of the transmitter and/or the message length is matched to the time the receiver(s) pass within range of the transmitter so that each receiver is able to capture at least one complete burst in the available time. The transmitter may be relatively fixed, for instance on a highway overpass, for communicating with vehicles passing on the highway. Alternatively, the transmitter may be mounted on an emergency vehicle to warn vehicles ahead or on intersecting roads that the emergency vehicle is approaching. In this case, the transmitter may adjust its effective range based on the speed of the emergency vehicle itself.

### BACKGROUND OF THE INVENTION

1. Field of the Invention

The invention pertains to apparatus and methods for mobile communications, and more particularly to apparatus and methods for delivering compressed messages to receivers within a localized area while adapting to the speed of either the receivers or the transmitter, or both.

2. Description of Related Art

There is at present a compelling need to create local, regional and national emergency information systems capable of notifying and alerting individuals of situations within a specifically affected area by delivering a complete and point specific audio and/or video message explaining the circumstances and course of action to be taken. These situations could vary from local emergency vehicle first responders using Code 3 to national security issues involving attack or terrorism.

For example, many serious automobile accidents could be avoided if drivers were warned in advance of approaching First Responder emergency vehicles. In 2004, across the nation there were 4,301 accidents involving ambulances resulting in 31 deaths and 563 injuries; 2,637 accidents involving fire trucks resulting in 21 deaths and 706 injuries; and 26,639 involving police cruisers resulting in 106 deaths and 7,344 injuries as stated by the National Safety Council, National Highway Traffic Safety Administration. In addition, over 60,000 “wake effect” crashes occur annually from emergency units confusing and/or startling other drivers as a result of Code 3 responses.

One familiar means of conveying brief warnings or other useful information to passing motorists is the use of programmable message boards. These devices are simple and reliable, particularly when used for routine messages such as travel time from the selected point to the city center. They can be easily updated with new messages but the nature of the display limits the size and complexity of the message that can be displayed (usually a phrase or very brief sentence or headline).

Greneker et al., in U.S. Pat. No. 5,917,430, issued Jun. 29, 1999, disclose a system in which a warning device transmits a coded signal on a frequency commonly used for traffic radar devices. Suitably capable radar receivers can interpret this code and display a very brief text message selected from a short list of stored messages (e.g., sixty-four). Less sophisticated radar receivers, while unable to interpret or display the message, will nevertheless activate a general alarm because of having detected the radar signal, thus providing at least some motivation for the driver to exercise greater caution over the area in question.

Various systems have been proposed that fall under the general category of “smart highway” initiatives. These concepts involve various degrees of communication between vehicles, vehicle-mounted sensors, roadway-mounted sensors, and the like. As an example, if a vehicle begins to skid, an on-board sensing and transmitter system might relay the existence of slick pavement to warn other vehicles approaching the area. Some aspects of such systems are disclosed by Chasek in U.S. Pat. No. 5,847,663, issued Dec. 8, 1998.

It has long been recognized that any sort of wireless communication or warning system will only work if the receiver is turned on and set to annunciate the message. Various ways of configuring a receiver to accomplish this are described by Poltarak in U.S. Patent Application Publication No. US 2003/0216133, dated Nov. 20, 2003.

Other systems have been developed to communicate wirelessly with passing vehicles on a very localized basis, for example, to collect tolls, gain admission to parking facilities, etc. Many such systems involve a stationary transceiver that extracts information from a generally passive transponder or RFID tag carried in the vehicle. RFID tags themselves, and their supporting infrastructure, are very mature technology in wide use for many applications besides traffic systems.

Systems have also been developed that allow trucks to interact wirelessly with weigh stations, for example, to avoid stopping if the truck has already been weighed by a weigh-in-motion device. Such systems receive information from the vehicle and in turn transmit instructions to the driver through an in-cab monitor. The PrePass® system [implemented by Affiliated Computer Services, Inc.] is typical of the art. This system does not transfer detailed messages to the driver, but simply displays a red light or green light to indicate whether or not the truck must pull into the weigh station.

### OBJECTS AND ADVANTAGES

Objects of the present invention include the following: providing an apparatus capable of transmitting compressed messages over a geographically localized area; providing an apparatus capable of transmitting compressed messages to mobile receivers as the receivers pass through a localized area; providing an apparatus capable of transmitting compressed messages to moving receivers while compensating for the speed of the receivers to assure that each receiver captures the compressed message; providing an apparatus capable of transmitting compressed warning messages from a moving transmitter to moving or stationary receivers; providing an apparatus capable of transmitting compressed messages from a moving transmitter to moving or stationary receivers while compensating for the speed of the transmitter to assure that the compressed message is received by receivers within an area being approached by the moving transmitter; and, providing a method for delivering compressed messages to moving or stationary receivers from a moving or stationary transmitter while minimizing interference with other communications. These and other objects and advantages of the invention will become apparent from consideration of the following specification, read in conjunction with the drawings.

### SUMMARY OF THE INVENTION

According to one aspect of the invention, an apparatus for communicating with mobile receivers comprises: a transmitter configured to transmit compressed data in burst mode over a selected localized area; a plurality of receivers; and, a sensing device configured to measure the speed of at least one of the receivers relative to the transmitter, wherein the transmitter is further configured to modify at least one parameter of the transmission in response to the speed measurement.

According to another aspect of the invention, an apparatus for communicating with mobile receivers comprises: a mobile transmitter configured to transmit compressed data in burst mode over a selected localized area; a plurality of receivers; and, a sensing device configured to measure the speed of the mobile transmitter, wherein the transmitter is further configured to modify at least one parameter of the transmission in response to the speed measurement.

According to another aspect of the invention, a method for communicating with mobile receivers comprises the steps of:

a. compressing a selected message sufficiently to allow the message to be transmitted in burst mode in less than about one second at a selected frequency;

b. operating a transmitter in burst mode at a selected power level that defines a selected effective range;

c. measuring the relative speed of the transmitter and at least one of the receivers; and,

d. adjusting at least one parameter of the transmitter in response to the relative speed.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic diagram of one embodiment of the present invention.

FIG. 2 is a schematic diagram of another embodiment of the present invention.

FIG. 3 is a schematic diagram of a fixed broadcast system having a transmission footprint adjustable to account for traffic speed.

FIG. 4 is a schematic diagram of a mobile broadcast system having a transmission footprint adjustable to account for the speed of the vehicle carrying the transmitter.

### DETAILED DESCRIPTION OF THE INVENTION

In its most general form the invention comprises a system to transmit messages in compressed bursts over a fairly well defined and limited geographic area, to receivers that are preferably carried in motor vehicles. The transmitter may be substantially fixed (e.g., on a highway overpass) or it may be moving (e.g., on an emergency vehicle) as will be described in greater detail in the examples that follow. The invention further comprises an adaptive system to adjust for the prevailing speed of the receivers (relative to the fixed transmitter) or for the speed of the moving transmitter (relative to the roadway), so that each receiver has sufficient time to receive the message while in the transmission zone. The adjustment may be accomplished by altering any or all of several parameters such as the power of the transmitter, the gain or radiation pattern of the antenna, the amount of data compression, the length of the message, the repetition rate of the burst transmissions, and so forth.

In one embodiment of the invention, a transmitter is disposed at a fixed location relative to a roadway. It will be appreciated that the apparatus may be mounted on a highway overpass, a sign, or other fixed structure; alternatively, the apparatus may be movable, for example, to allow it to be towed to a desired location and set up for a desired period of time, then towed to a different location. The latter feature might be used to warn of temporary hazards such as construction zones and the like. The following example describes the components of a fixed transmitter in accordance with the present invention.

### EXAMPLE

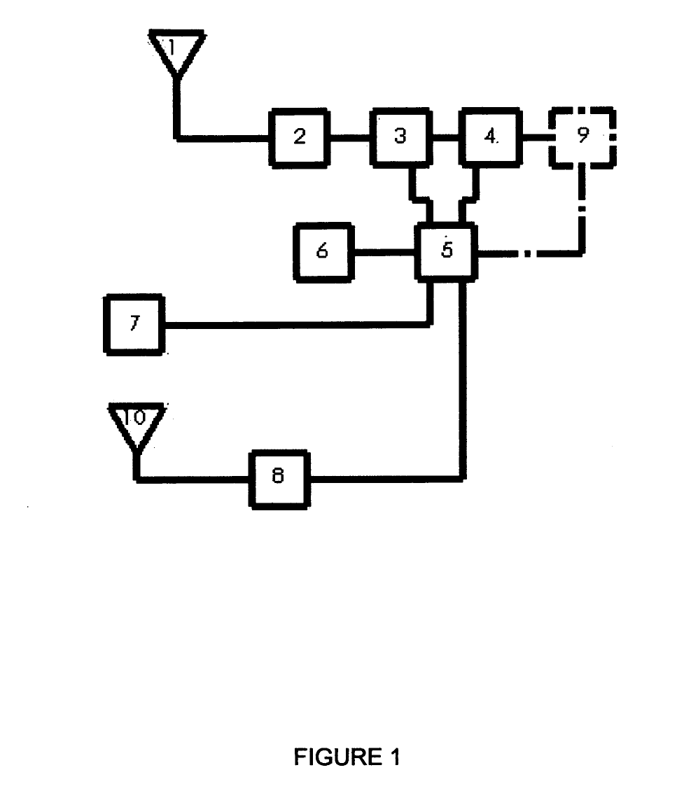

FIG. 1 is block diagram of a fixed transponder system. Indicated at 1 is a transmit/receive antenna, such as a Nearson Model 800 patch antenna. Signals from the system administrator, preferably in a selected channel within the IEEE 802.11 a band, are received via antenna 1, and directed to the receiver/transmitter 4, such as an Atheros AR5006EXS. The receiver contains an antenna switch for selecting receive or transmit mode, the default mode being receive. The incoming signal is then directed to the data processing and control 5, for example a Sockrig Engineering MET 5501 with associated plug in analog to digital and digital to analog interface modules and data storage area 6, such as a Fujitsu HDD 40 GB Hard Drive. It will be understood that the particular devices used for the aforementioned functions are intended for illustrative purposes only. Skilled artisans will appreciate that many alternative or functionally equivalent microprocessor/data storage based systems could be used.

In operation, the incoming signal from the system administrator contains a desired message (digital data, voice message, text message, video, etc.) to be transmitted to a target vehicle or vehicles, along with any dynamic system control instructions, if desired or needed. All communications may be encrypted to prevent unauthorized use.

A doppler radar transceiver 7, for example a Microwave Solutions MDV 4220, detects an approaching vehicle and outputs a frequency, 31 Hz/mph, based on the vehicle's velocity. This frequency is then converted to velocity with a custom program within the data processing system 5. Based on the acquired target vehicle velocity, and a custom velocity to burst rate conversion program, the control system determines the required burst rate, and provides the stored information to the receiver/transmitter 4. (Alternatively, the control program may determine the required antenna input power to insure complete reception of the information by the target vehicle, and preferably adjusts the gain of a variable gain drive amplifier 3, such as Fairchild RMM2080. The signal then passes through the power amplifier 2, a Nextec NA0053 and is launched in the direction of the approaching vehicle by antenna 1.

A possible velocity to burst rate selection, which is implemented by a custom programmed algorithm within the control system, is shown in the following table. By selectively reducing the burst rate to the lowest possible level required to insure complete in formation transfer, the occupied channel bandwidth is reduced thereby reducing adjacent channel interference. Also, by reducing transmitting power to a minimum, the reduced RF footprint reduces potential interference with competing same-channel transmissions, in what is expected to be a very crowded band.

Table of velocity to bit rate conversion

| Target Velocity, | |
|---|---|
| mph | Bit rate, Mb/sec |
| <20 | 6 |
| 30 | 9 |
| 40 | 12 |
| 50 | 18 |
| 60 | 24 |
| 70 | 36 |
| 80 | 48 |
| 90+ | 54 |

In an alternate embodiment, an additional element 9, can be added containing chirp radar detection circuitry to obtain the target vehicle velocity. In this arrangement element 7 could be eliminated, with the doppler chirp transmission provided by the transmitter 4. Control of the chirp and interpretation of the received data would be performed by control system and software 5.

Block 8 is a GPS module, for example, a Lassen IQ GPS Receiver, connected to a Ultra-Compact embedded HFL antenna 10. The GPS receiver provides transponder position coordinates which are stored in the data storage area 6, for use by the system and administration for an identification and communication protocol, if needed.

If the target vehicle is equipped with a mobile transceiver module containing a GPS module, the target vehicle may be queried by the fixed transponder, to transmit its velocity data. The transponder control system may then use the acquired data to select the message burst length and transmit power. The transponder may also add an end of message data bit, such that when the mobile transceiver receives this bit, it replies with an indication that the message has been received. If message acknowledgement is not detected by the fixed transponder, it is resent.

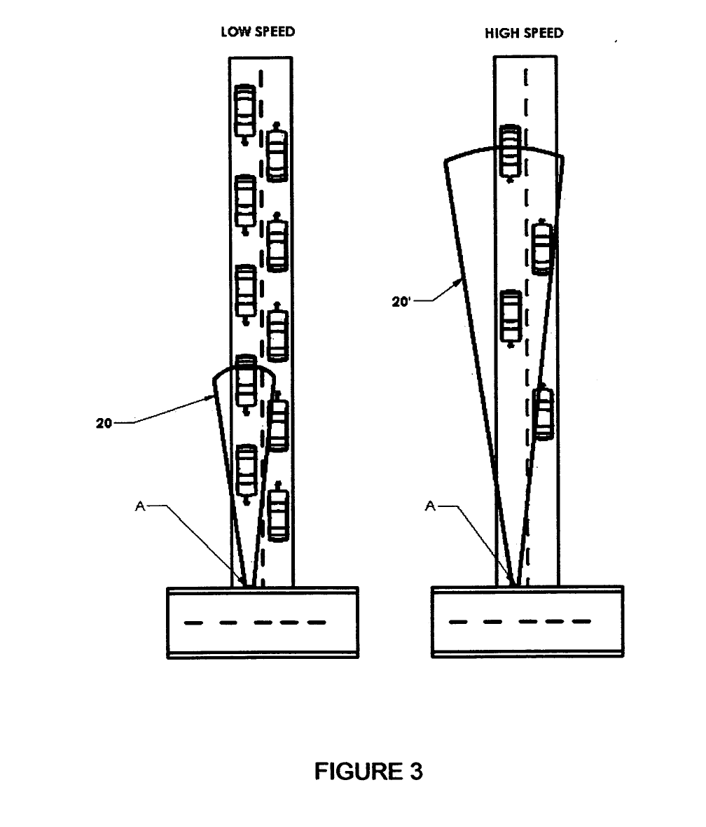

It will be understood that in many circumstances the invention will be deployed in areas of heavy traffic flow. In this case the speed measurement module 7 or 9 may conveniently monitor the generally prevailing traffic speed (as opposed to determining the speed of any one particular vehicle) and adjust one or more of the transmission parameters (transmit power, bit rate, antenna gain or directionality, etc.) based upon this generally prevailing traffic speed, whereby the RF footprint 20, 20′, coupled with the message length or bit rate, is sufficient to ensure that vehicles passing through the footprint have adequate opportunity to receive the entire message as illustrated generally in FIG. 3.

Various well-known methods of data compression may be used with the inventive system to increase information capacity. Video transmissions of considerable size may be provided by the use of an MPEG-4 Encoder/Decoder module such as a Delta Digital Video VCM 042. The size of the information package would ultimately be determined by the data storage capacity, traffic speed, transmitter power, and other system variables.

The transmitter, either stationary or mobile, is capable of receiving audio and/or video digital blocks ranging in varying lengths via wireless cellular phone, telephone land line or manual input. The transmitter compresses the digital audio and/or video block and burst broadcasts the information repetitively in very small intervals of time, preferably less than about 2.5 seconds, the length of which is specifically correlated to the length of the real time information block that is being transmitted. The receiver, either stationary or mobile, receives the compressed digital low power radio frequency burst broadcast, decompresses it and plays it back in its original length to the intended person and/or persons. The receiver can include but is not limited to FM radios; portable music players; personal text messaging devices; personal data assistants; cell phones; pagers; receiving devices specifically engineered to work with the inventive system; lap tops; or any other electronic device capable of receiving a digital signal. As used herein, the term “broadcast” includes any useful information content, which may include audio or voice messages, simple audible alerts or warning sounds; moving or still video images, simple text or machine-readable data files.

It can be seen that an important aspect of the invention comprises a methodology wherein the transmitter establishes an effective geographic range or “footprint” based on various considerations. These considerations may include how much power is available, what other sources of interference may be nearby, the need to restrict the range enough to avoid licensing the transmitter, and so on. At the same time, there is a desire to ensure that passing vehicles remain within the footprint long enough to receive at least one complete transmission. Thus, as the prevailing speed of traffic increases, the footprint may be expanded (in the direction of travel) by increasing the output power of the transmitter or by increasing the gain on the antenna, as shown schematically in FIG. 3. For example, suppose the desired message bursts are one second long, separated by one second, and it is determined that for an adequate margin of safety each vehicle should be within the effective range for three complete transmissions. In this case the range of the transmitter should cover the distance each vehicle will travel in six seconds. At 30 mph (44 feet per second) the transmitter should have a minimum range of 264 feet, whereas at 60 mph (88 feet per second) the necessary range will be 528 feet ceteris paribus.

It will be appreciated that the antenna may be configured to radiate in a directional pattern, thereby increasing the range in the direction of travel while minimizing transmission in the orthogonal direction to reduce wasted power and minimize interference with other systems in the area. Alternatively, the footprint can remain fairly constant and the system can adjust the length of the burst, by shortening the message when the prevailing speed increases or introducing more compression so that audio quality may degrade but the complete amount of information will still be conveyed. Those skilled in the art will appreciate that the approach used to adapt the inventive system to particular situations will depend to some degree on the type of receiver being used. Through routine engineering design, trade-offs relating to transmitter complexity versus receiver complexity may be made for any given application.

It will be appreciated that the invention may be carried out using any suitable speed measurement technique. In addition to the exemplary embodiments, other embodiments might use doppler laser or millimeter-wave devices as are known in the art. Radar-based devices may operate on any of the familiar frequency bands approved for such devices.

The system described in the foregoing example may be used for various purposes, particularly to deliver warnings to motorists regarding traffic or weather conditions, accidents or construction activities, or other off-normal situations. It will be appreciated that the system may be updated through a dedicated wireless link, cellular phone connection, or hard-wired cable system, depending on such familiar engineering variables as location, accessibility, cost, etc. It is contemplated that such a system may be integrated into the broader system of traffic control and monitoring to complement other familiar elements of modern traffic engineering such as fixed signs and message boards while providing more information (typically about one minute of audio) than can be practically conveyed to a moving vehicle by programmable message boards. The system may operate as a QoS system to further enhance its utility.

As used herein, the term QoS refers to Quality of Service, a concept employed in telecommunications. There are multiple levels, which are designated by a standardized data byte, which allows a transmission to assign a level of importance for the transmission. The higher level will interrupt a transmission being received at a lower level. A purely commercial message, for instance, might be a level 5, allowing it to be preempted by a severe weather bulletin, which might in turn be preempted by a message regarding a natural catastrophe or terrorist alert.

In the fields of packet-switched networks and computer networking, the traffic engineering term Quality of Service refers to resource reservation control mechanisms. Quality of Service can provide different priority to different users or data flows, or guarantee a certain level of performance to a data flow in accordance with requests from the application program or the internet service provider policy. Quality of Service guarantees are important if the network capacity is limited, for example in cellular data communication, especially for real-time streaming multimedia applications, for example voice over IP and IP-TV, since these often require fixed bit rate and are delay sensitive.

In addition to use by traffic control agencies, the invention has applications in purely commercial settings as described in the following example.

### EXAMPLE

A device such as described in the previous example may be mounted on a billboard or other landmark. Passing motorists may see the sign and then receive a burst transmission containing extended commentary on the same subject. The commentary may be updated relatively infrequently, for example, providing driving directions or admission price to the advertised attraction, hours of operation, etc. Alternatively, the commentary may be updated as often as desired, for example, providing news headlines as a complimentary service of the advertiser.

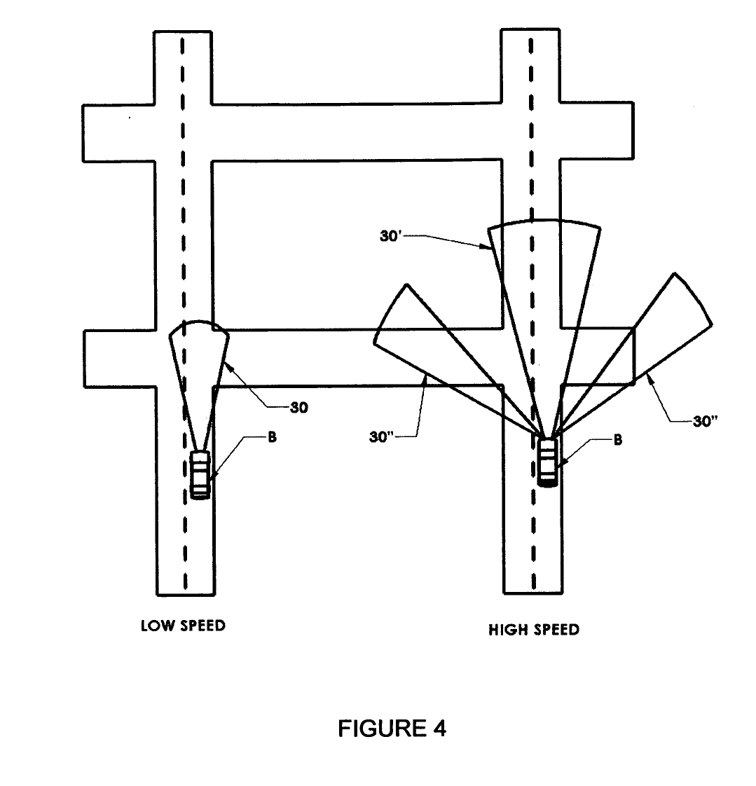

The rationale for the repetitive burst broadcasting of small intervals of time is to enable a mobile receiver moving at a high rate of speed through a small and defined footprint (area of broadcast) near a stationary transmitter to receive the information burst, decompress it and replay the message in its real time entirety. In turn, this also allows a mobile transmitter that is moving at a high rate of speed to send a compressed digital burst broadcast over a defined moving geographical area surrounding the transmitter to either stationary or moving receivers that are in the path of the moving transmitter as shown schematically in FIG. 4.

The inventive alert system transmitter may also be usefully employed on moving vehicles (primarily emergency responders). It is well known that many accidents involve collisions between emergency vehicles and other traffic. These collisions can arise because drivers fail to see or hear the approaching emergency vehicle, particularly if the emergency vehicle is approaching on a street that crosses the path of the other vehicle. Furthermore, in some cases, inexperienced drivers may panic or otherwise react inappropriately if they suddenly encounter the emergency vehicle, whereas had they been given more warning they could have reacted in a more deliberate way.

### EXAMPLE

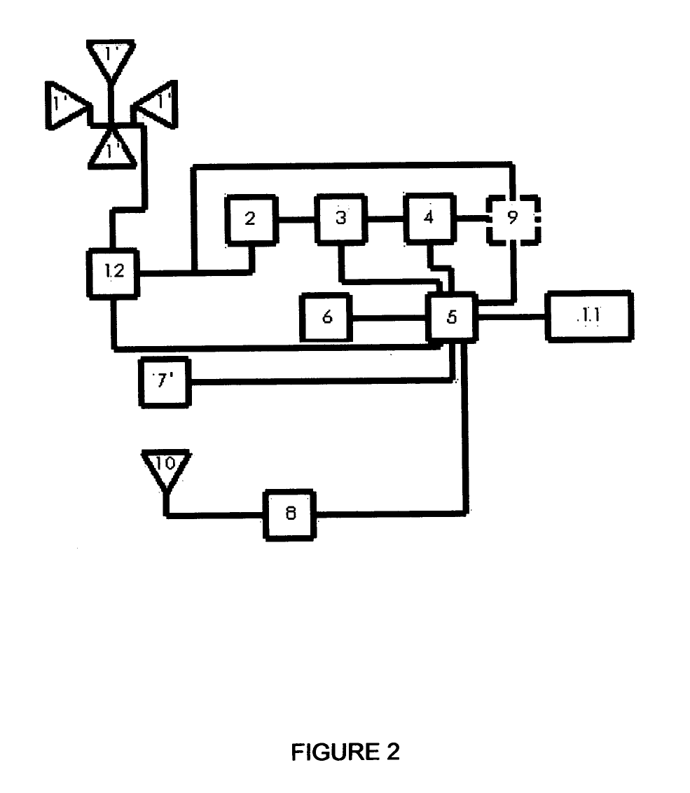

FIG. 2 is a block diagram of a mobile administrator transceiver suitable for deploying in an emergency vehicle, for example. The system uses many of the same components as described in the preceding examples and shown schematically in FIG. 1, with one difference being that the speed measurement function 7′ is configured to measure the speed of the mobile transmitter itself, rather than the prevailing speed of traffic relative to a fixed transmitter as described previously. This may be done using a properly configured on-board radar system, a GPS module (indicated generally at 8 with its associated antenna 10), or an interface with the vehicle's speedometer.

Another difference involves means to adjust the lateral extent of the transmission “footprint” to transmit warnings to vehicles approaching from cross streets. This may be accomplished by an array of four directional antennas 1′ disposed facing forward, rearward, rightward, and leftward as shown schematically in FIG. 2.

If the administrator is aboard the mobile unit, the desired information to be transmitted may be entered manually using various standard PC interface components, such as an ASCII standard keyboard for text messages, a CD/DVD drive for photo video, and or audio, or any other device compatible with the system's operating software and preferably communicating via a USB2.0 interface or a DB9 serial connection. The system preferably is also capable of receiving the desired information packet from a remote administrator and retransmitting, as generally described in FIG. 1. In some cases, the system may simply be preset with a message such as “Emergency vehicle approaching!” thereby serving as a sort of “smart siren” that is adaptive to the speed of the vehicle. The on-board receiver transmitter, along with software control in the control computer may be operated as a QoS system, allowing control of the system by hierarchal command override codes. This allows overriding an in-progress transmission, such as that of an emergency vehicle in route to a fire or accident with a more urgent national security or terrorist alert.

The desired information, generated locally or remotely, is input into the control computer 5, and is stored in the data memory area 6. When the command to transmit is given, locally or remotely, the information is passed to the transmitter 4, MAC (Media Access Control) and baseband processed, and converted to radio frequency signals, preferably in accordance with IEEE 802.11a specifications. The RF signals then pass to the gain control amplifier 3, where the signal levels are boosted to the desired level as determined by a command input to the control computer. The signals then pass to the power amplifier 2, and on to the antenna selector switch 12, for example, a MA-COM MA4AGSW4.

The antenna switch 12 sequentially connects the RF signal to four antennas 1′, (the Neason Patch Antenna Model 800 Patch and the Hyperlink Technologies 5.8 GHz Sectorized Omni Array are suitable devices). Each antenna is preferably arranged to cover 90 degrees, or one quadrant of a 360 degree transmission footprint, such that selected areas in front, behind, left, and right of the mobile unit may be covered. Alternatively, narrower sectors may be employed if desired. As an emergency vehicle, for example, (indicated at B in FIG. 4) begins the trip from the original location, the systems control computer can be instructed to provide a 360 degree transmission footprint with an operator selected radius, for instance, one mile. If the control computer is interfaced with a GPS system 8, and has preloaded highway maps with turn by turn instructions, then as the vehicle proceeds on its route, the transmitting antenna will automatically respond to the highway changes. On a single stretch of highway with no side entrances, the antennas would transmit to the front (and optionally to the rear) of the vehicle, giving a transmission footprint 30 as shown generally in FIG. 4. The rearward antenna may also be used when the vehicle is stopped, to alert vehicles approaching from behind. If the traveling vehicle encounters cross streets, the side-looking antennas may be energized, and furthermore the overall transmission footprint 30′, 30″ is increased as the vehicle's speed increases as shown in FIG. 4. Thus, anywhere from one to four antennas may be transmitting at any given time, based upon speed and traffic conditions, and the power, antenna gain, and/or burst rate are adjusted based on vehicle speed. The invention therefore allows the RF energy to be directed only where it is needed and helps reduce interference with other operating systems in the immediate area.

The inventive system also lends itself to incorporation into various standard traffic control systems, whereby more efficient use of existing infrastructure may lower total costs and speed the widespread adoption of the inventive method.

Although the exemplary embodiments illustrated in FIGS. 3 and 4 illustrate devices generally deployed for use in vehicular traffic on streets and highways, it will be appreciated that the invention may be advantageously used in conjunction with railway traffic, river traffic, and the like.

The foregoing examples are provided to illustrate various aspects of the invention. Applicants do not intend for the invention to be limited to these exemplary embodiments, but rather to include all other modifications and variations of the invention that fall within the spirit and scope of the invention as defined by the following claims.

We claim:

1. An apparatus for communicating with mobile receivers comprising:
a transmitter configured to transmit compressed data in burst mode over a selected localized area;
a plurality of receivers configured to receive said transmitted data; and,
a sensing device capable of measuring the speed of at least one of said receivers relative to said transmitter,
wherein said transmitter is further configured to modify at least one parameter of said transmission in response to said speed measurement.

2. The apparatus of claim 1 wherein said transmitter is substantially stationary and said sensing device measures a characteristic speed of at least one moving vehicle whereby the speed of said mobile receivers may be inferred.

3. The apparatus of claim 1 wherein said transmission parameter comprises at least one characteristic selected from the group consisting of: transmitter output power; antenna gain; antenna radiation pattern; burst length; burst repetition rate; and data compression.

4. The apparatus of claim 1 wherein said sensing device comprises a device selected from the group consisting of doppler radar devices; doppler laser devices; millimeter-wave radar devices; chirp radar devices; and GPS measurement systems.

5. The apparatus of claim 1 wherein said transmitter is disposed in a moving vehicle and said receivers may be moving in various directions relative to said transmitter and relative to one another.

6. The apparatus of claim 5 wherein said sensing device is configured to measure the speed of said vehicle using an interface with said vehicle's speedometer, and said transmitter is configured to modify at least one parameter of said transmission in response to said speed measurement.

7. The apparatus of claim 1 wherein said compressed data comprises data that may be decompressed to provide at least one message type selected from the following group: audio messages; voice messages; emergency warnings; video messages; text messages; coded messages; and still images.

8. An apparatus for communicating with mobile receivers comprising:
a mobile transmitter configured to transmit compressed data in burst mode over a selected localized area;
a plurality of receivers; and,
a sensing device configured to measure the speed of said mobile transmitter,
wherein said transmitter is further configured to modify at least one parameter of said transmission in response to said speed measurement.

9. The apparatus of claim 8 wherein said transmission parameter comprises at least one characteristic selected from the group consisting of: transmitter output power; antenna gain; antenna radiation pattern; burst length; burst repetition rate; and data compression.

10. The apparatus of claim 8 wherein said sensing device comprises an interface to the speedometer of the vehicle carrying said transmitter.

11. The apparatus of claim 10 wherein said transmitter is configured to transmit in a first pattern when said vehicle is moving and configured to transmit in a second pattern when said vehicle is stationary.

12. The apparatus of claim 11 wherein said selected localized area comprises an area ahead of said vehicle when said vehicle is moving and said localized area comprises an area behind said vehicle when said vehicle is stationary.

13. A method for communicating with mobile receivers comprising the steps of:
a. compressing a selected message sufficiently to allow said message to be transmitted in burst mode in less than about two seconds at a selected frequency;
b. operating a transmitter in burst mode at a selected power level that defines a selected effective range;
c. measuring the relative speed of said transmitter and at least one of said receivers; and,
d. adjusting at least one transmission parameter of said transmitter in response to said relative speed.

14. The method of claim 13 wherein said selected message comprises at least one message type selected from the following group: audio messages; voice messages; emergency warnings; video messages; text messages; coded messages; and still images.

15. The method of claim 13 wherein said step of measuring relative speed employs a device selected from the following group: doppler radar devices; doppler laser devices; millimeter-wave radar devices; chirp radar devices; and GPS measurement systems.

16. The method of claim 13 wherein said transmission parameter comprises at least one characteristic selected from the group consisting of: transmitter output power; antenna gain; antenna radiation pattern; burst length; burst repetition rate; and data compression.
